(19) United States
(12) Patent Application Publication
(10) Pub. No.: US 2013/0087719 A1
(43) Pub. Date: Apr. 11, 2013

(54) LIGHT SOURCE DEVICE FOR TIME-DELAYED DETECTION OF FLUORESCENCE, AND IMAGE PICK-UP SYSTEM AND METHOD

(71) Applicant: Lumos Technology Co., Ltd., Taipei (TW)

(72) Inventor: Chih-Yi Yang, Taipei (TW)

(73) Assignee: Lumos Technology Co., Ltd., Taipei (TW)

(21) Appl. No.: 13/691,726

(22) Filed: Nov. 30, 2012

Related U.S. Application Data
(63) Continuation-in-part of application No. 12/856,405, filed on Aug. 13, 2010, now abandoned.

(51) Int. Cl. G01N 21/64; H05B 37/02

(52) U.S. Cl. CPC G01N 21/64; H05B 37/02
USPC 250/459.1; 250/458.1; 315/287; 250/208.1

(57) ABSTRACT

The present invention discloses a light source device, image pick-up system and pick-up method for time-delayed detection of fluorescence, essentially applying a pulsed-excitation light source installed inside a light source device in conjunction with a shutter to pick up a photoluminescence image of an object located at a predetermined detection site, the light source device comprising: a pulsed-excitation light source for emitting light towards the predetermined detection site; and a controller for instructing the pulsed-excitation light source to emit light, the controller being connected in feedback signals to the shutter, thereby closing the shutter when the pulsed-excitation light source emits light and opening the shutter as soon as the light pulse terminates in order to effectively shield reflection light and diffusive reflection light to purely capture the photoluminescence data.

### CROSS-REFERENCE TO RELATED APPLICATIONS

This application is a continuation-in-part of U.S. application Ser. No. 12/856,405, filed on Aug. 13, 2010, the contents of which are incorporated herein by reference.

### BACKGROUND OF THE INVENTION

1. Field of the Invention

The present invention generally relates to a light source device, image pick-up system and pick-up method thereof; in particular, the present invention relates to a light source device for time-delayed detection of photoluminescence image data, an image pick-up system and a photoluminescence image pick-up method.

2. Description of Related Art

Advancements in modern optical technologies obfuscate differentiations between various image capturing devices, such as video recorders, cameras, camera phones, and clear pictures can be obtained even with a general camera phone. Additionally, fluorescent image applications become more and more comprehensive in recent years, so relevant industries gradually pay attention to devices enabling the fluorescence image pick-up feature. In practice, except conventional applications in ecological observations and scientific researches, the fluorescent imaging technique can be further utilized in various fields such as medical cosmetic surgeries, criminal identifications or anti-counterfeit verifications; for example, fingerprint verifications, paper bill anti-counterfeit authentications, or even detections of fluorescent proteins in body fluid for blood or body fluid searches.

Generally speaking, the photoluminescence imaging is essentially to project the incident light of a higher frequency onto an object under detection characterized in fluorescence or phosphorescence features such that the fluorescent or phosphorescent molecules in the object under detection, e.g., green fluorescence protein (GFP), absorb photons in the wavelength range of ultraviolet light, such as at 365 nm, and become excited, and then electrons in the excited molecules jump back from higher energy tracks to the base state, thus emitting fluorescent or phosphorescent light of a lower frequency at, for example, 525 nm.

However, during the photoluminescence process, most of the emitted light beams from the excited light source may not be absorbed by the fluorescent molecules, but simply projected onto the surface of the object under detection and directly reflected or diffusively reflected. In other word, since the brightness of the reflection light can be usually thousands or even tens of thousands times higher than the fluorescent light emitted from the object under detection, and only very few light beams, say 1%, of it can effectively enter into the sensing components, such a noise reflection light or diffuse reflection light may severely interfere with the signals of the aforementioned photoluminescence image thus causing difficulties in observation.

Further considering other noise light interferences from the external environment, e.g., a site under intense sunlight exposures, in searching for blood traces scattered on the ground by using artificial ultraviolet light sources in order to locate positions of such blood traces based on the photoluminescence reaction, it is very likely to obtain erroneous determinations due to strong ambient sunlight so the existence of fluorescent or phosphorescent light traces may be undesirably overlooked.

Consequently, professionals in relevant fields of criminal identifications, biological or physiological researches or medical cosmetic business all intend to be able to differentiate such reflection light sources or external noise light from the photoluminescence image data thereby acquiring the accurate photoluminescence information. As shown in FIG. 1, a currently available auxiliary light source 9 can emit light with an ultraviolet lamp and guide the emitted light by means of a bellow tube 91, so a user may freely bend the bellow tube 91 to an appropriate angle thus allowing the light source to project light on the object under detection with close lateral illumination and preventing the directly reflected light of the emitted light from immediately returning to the camera lens thus eliminating interferences to fluorescent or phosphorescent images.

Whereas, due to limitations in the bellow tube 91, such a structure of light source angle adjustment can not provide precise modification results on the bend angle of bellow tube 91 and, on the other hand, the light sources can be arranged on only two directions so the shadow of the object under detection may occur and the light projection can not be evenly distributed, leading to unsatisfactory illumination effects. Additionally, in case the object under detection is a living body, such as a zebra fish or maggot, excessively strong or continuous exposures under the excited light source can cause the temperature in the observation environment to elevate, and such an increased temperature may be lethal to the living body. Besides, in collecting a fingerprint on a glass cup, for example, due to the existence of the bellow tube, it is not possible to easily get rid of external noise light with a simple light mask, so the quality in captured images may deteriorate or even become a failure in a worst case.

As shown in FIG. 2, the specification in the patent application U.S. Pat. No. 12/856,405 of the present inventor discloses that, to resolve issues concerning the aforementioned uneven illumination distribution and overly high temperature or the like found in prior art, multiple light emitting diodes (LEDs) 91′ can be applied and arranged in a ring configuration to allow a camera 90′ or other image pick-up device to acquire intended fluorescent images. Moreover, the patent application U.S. Pat. No. 12/758,028 of the present inventor also proposes an illumination angle alternation method thereby enabling effective auxiliary light sources for dark field images.

But, it should be appreciated that, no matter how the illumination angle of the light source varies, it can at best eliminate the most intense jamming light beam from the direct reflection; whereas, since the surface of a general object can not be absolutely flat, under light projection, randomly scattered reflection light toward different directions may occur, and such a diffusive reflection phenomenon can not be easily excluded through the above-said light source angle modification approach. Further, in comparison with the feeble fluorescent or phosphorescent light, such a diffusive reflection light may become a serious interference factor to a certain significant degree.

Additionally, to reduce physical damages to a patient's body, endoscope surgeries are broadly applied at present in many medical examination fields. The so-call endoscope surgery mostly utilizes a wider external pipe to stretch into a patient's diseased portion, and an optical fiber is installed within the flexible pipe for guiding an outside light source into the diseased portion and illuminating it. The image of the diseased portion can be then taken and transmitted to an external screen for further medical observations and analyses. Some precision mechanisms can be further installed on the outer pipe of the endoscope stretched into the patient's body, for example, a supersonic probe for wound burning or closure or a mechanical clip for retrieving partial body tissues, thereby allowing medical staff to perform examinations or minimally invasive surgeries in time.

In particular, because cancer variant cells, for example, can induce blood vessel regenerations to take over the nutrition of normal cell tissues in order to abnormally grow up and proliferate, it is very often to find unusually dense blood vessel distributions near the diseased portion of a cancer patient, which is also recognized as a common approach for determining the existence of cancer focus. To deal with this type of disease, medical staff can inject saline doped with fluorescent, phosphorescent or radioactive dyes into blood vessels, and then identify and locate regions featuring photoluminescence or high radiation responses thereby judging the focal locations and areas. For example, Haematoporphyrin Derivative (HpD) can emit red fluorescent light under light source illumination.

Unfortunately, to prevent from impairing the patient's body, the required structural devices need to be set up as many as possible inside the tiny pipe diameter of the endoscope, so it is not possible to provide multiple LEDs directly surrounding the diseased portion in order to illuminate from different directions, as in the aforementioned cases regarding to criminal identifications or living body researches. That is, the light source is limited to be guided therein from outside with typically vertical projection onto the focal area, and then the captured image of the focal area is reflected and returned along almost the same path. Due to the structural restrictions thereof, noise light interferences from the direct reflection light is totally unavoidable, thus the intensity of the truly required photoluminescence image is usually less than one percent of the direct reflection light, so the accuracy in medical determinations may be greatly reduced.

Furthermore, in order to filter such direct reflection light and diffusive reflection light, a filter lens of specific wavelength needs to be installed along the light path, commonly leading to 40% or more of filter losses, so the image data can not be clearly obtained during actual examination processes. Especially, in performing certain examinations, there may be two or more types of emitted fluorescent or phosphorescent lights, like green light excited by blue light and red light excited by green light. In the former reaction, the green light represents the required image data; in the latter reaction, however, the reflect green light indicates the noise light to be filtered, but currently available technologies are unable to differentiate these two green lights. Hence, it is necessary to apply an optical device of two different wavelengths to repeatedly perform twice the above-said examination processes, wherein one is for the green light image data, allowing the green light to pass; while the other one aims at the red light image data to block out the green light. Such an examination procedure can be troublesome, and the image data may not be correctly overlapped thus resulting in erroneous judgments.

It should be noticed that, no matter the direct reflection light or diffusive reflection light, they are both generated by the photons emitted from the light source, projected onto the surface of the object under detection and travelling back at the light speed, and accordingly can be considered as coming back “at the same time” as they are emitted. On the contrary, in fluorescence or phosphorescence materials, electrons in outer circles of each molecule absorb the photons coming from the excitation light, and subsequently, after a certain duration of time, numerous excited electrons randomly jump back to the original base state and thus the fluorescent or phosphorescent light is simultaneously emitted, so that, compared with the excitation light returning at nearly the same time as reflecting, fluorescence or phosphorescence light emissions may take longer time, indicating a time lag does exist thus postponing the time window for photoluminescence data observations. Therefore, the present invention specifically focuses on the issue concerning eliminating interferences caused by direct reflection light, diffusive reflection light or ambient light sources through exploiting such a temporal difference feature thereby increasing the quality of photoluminescence image.

### SUMMARY OF THE INVENTION

An objective of the present invention is to provide a light source device for time-delayed detection of fluorescence which is capable of using the temporal difference to effectively block out the return of the direct reflection light and diffusive reflection light in order to eliminate image interferences, thereby significantly enhancing the quality of photoluminescence image and possibility of successful image pick-up operations.

Another objective of the present invention is to provide a light source device for time-delayed detection of fluorescence which can operate in conjunction with a general optical image capture device to enable fluorescence or phosphorescence pick-up function thereby effectively increasing application flexibility.

Yet another objective of the present invention is to provide an image pick-up system for time-delayed detection of fluorescence which exploits the temporal difference to effectively block out the return of the direct reflection light and diffusive reflection light thereby significantly enhancing the quality of photoluminescence image and possibility of successful image pick-up operations.

Still another objective of the present invention is to provide an image pick-up system for time-delayed detection of fluorescence which includes a shield for further impeding the external background noise light to improve the quality of fluorescent images.

Yet another objective of the present invention is to provide an image pick-up system for time-delayed detection of fluorescence which exploits the temporal difference to enable improved medical fluorescence or phosphorescence determinations, increased medical care quality as well as reduced misjudgments and delays thereby ensuring more complete patient treatments.

Still another objective of the present invention is to provide an image pick-up method for time-delayed detection of fluorescence which uses the temporal difference to improve the possibility of successful image pick-up operations as well as the image quality, thereby effectively acquiring the desired information in the photoluminescence image.

Further still another objective of the present invention is to provide an image pick-up method for time-delayed detection of fluorescence which allows repeated on and off operations of excitation light illumination so that the fluorescence or phosphorescence information can be well aggregated to enhance the brightness in the photoluminescence image, thereby further elevating the possibility of successful photoluminescence image pick-up operations.

To achieve the aforementioned objectives, the present invention discloses a light source device for time-delayed detection of fluorescence, adapted for use with a shutter to pick up a photoluminescence image of an object located at a predetermined detection site, the light source device comprising: a pulsed-excitation light source for emitting light towards the predetermined detection site; and a controller for instructing the pulsed-excitation light source to emit light, the controller being signal-connected to the shutter for delayed open.

The image pick-up system according to the present invention can be configured by installing the aforementioned light source device for time-delayed detection of fluorescence onto an image pick-up system, comprising: a light source device for time-delayed detection of fluorescence, comprising a pulsed-excitation light source for emitting light towards the predetermined detection site, and a controller for instructing the pulsed-excitation light source to emit light; a shutter device which is closed when the pulsed-excitation light source is turned on and adapted to be opened after a predetermined time delay following termination of light emission from the pulsed-excitation light source upon receipt of a feedback signal from the controller; and an image pick-up device formed with an image data entrance corresponding to the shutter device.

In addition, the present invention further provides a method of picking up a photoluminescence image of an object located at a predetermined detection site using an image pick-up system comprising a light source device for time-delayed detection of fluorescence, a shutter device and an image pick-up device, wherein the light source device comprises a pulsed-excitation light source for emitting light towards the predetermined detection site, and a controller signal-connected to the pulsed-excitation light source, and wherein the image pick-up device is formed with an image data entrance corresponding to the shutter device, the method comprising the steps of: a) closing the shutter device, and allowing the controller to instruct the pulsed-excitation light source to emit light towards the predetermined detection site in a pulsed manner; and b) instructing the shutter device to open after a predetermined time delay following termination of the pulsed light emission, so that the image pick-up device is allowed to capture image data through the image data entrance.

The present invention can skillfully utilize the temporal difference between the fluorescent or phosphorescent light and the reflection light and, through the illumination of pulsed-excitation light source and synchronized control on the shutter switch, impede unwanted interferences coming from the direct reflection light and diffusive reflection light, but simply allow the photoluminescence image data emerging after the end of the reflection to pass, such that the light source device, image pick-up system and photoluminescence image pick-up method for time-delayed detection of fluorescence according to the present invention enables increased possibility of successful photoluminescence image pick-up operations as well as reduced noise light interferences and enhanced quality of the fluorescent images. Also, it may be further assisted with a shield for better filtering ambient noise light. Besides, the light source can be conveniently connected to a well-known optical apparatus, such as a camera, microscope, camera phone, or else purely for naked eye observations, which enables more comprehensive utilizations without compromising the quality of the fluorescent or phosphorescent light thereby satisfying various application requirements to achieve the aforementioned objectives.

### BRIEF DESCRIPTION OF THE DRAWINGS

FIG. 1 shows a stereo view of a currently available camera and auxiliary light source;

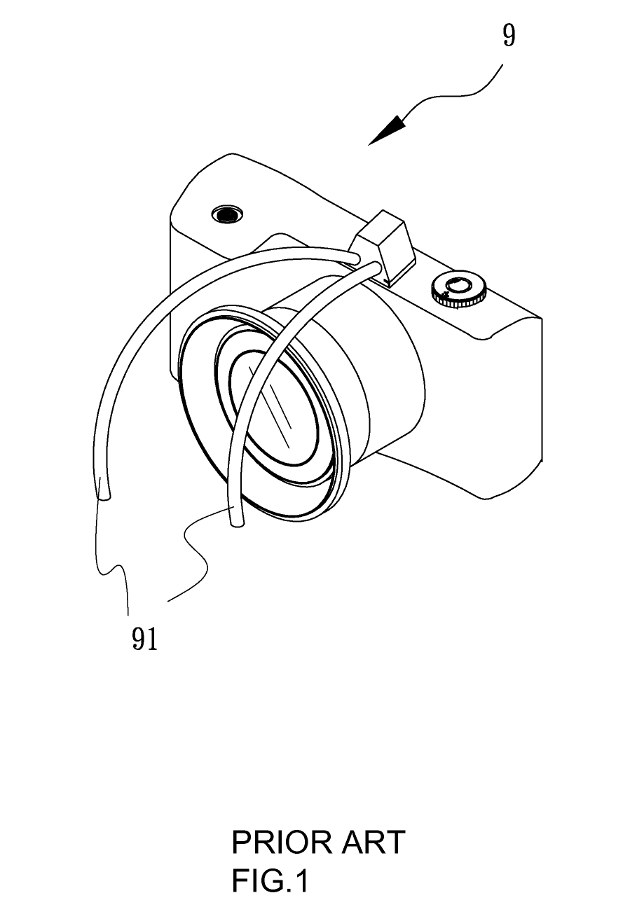

FIG. 2 shows a stereo view of another currently available camera and auxiliary light source, illustrating an auxiliary light source characterized in ring-wise illumination configuration and allowing the dark field image feature;

FIG. 3 shows a block diagram for the image pick-up system according to a first preferred embodiment of the present invention, illustrating the interactive relationships of the light source device according to the present invention in conjunction with a camera;

FIG. 4 shows an operation flowchart for the embodiment in FIG. 3;

FIG. 5 shows a second preferred embodiment of the present invention, illustrating how the light source device according to the present invention may operate conjunctively with a currently available endoscope;

FIG. 6 shows a structural diagram for a mechanical shutter in the light source device of the embodiment in FIG. 5;

FIG. 7 shows a stereo view of a third preferred embodiment according to the present invention;

FIG. 8 shows a side view for a fourth preferred embodiment according to the present invention, illustrating how the image pick-up system according to the present invention may operate conjunctively with a currently available microscope.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

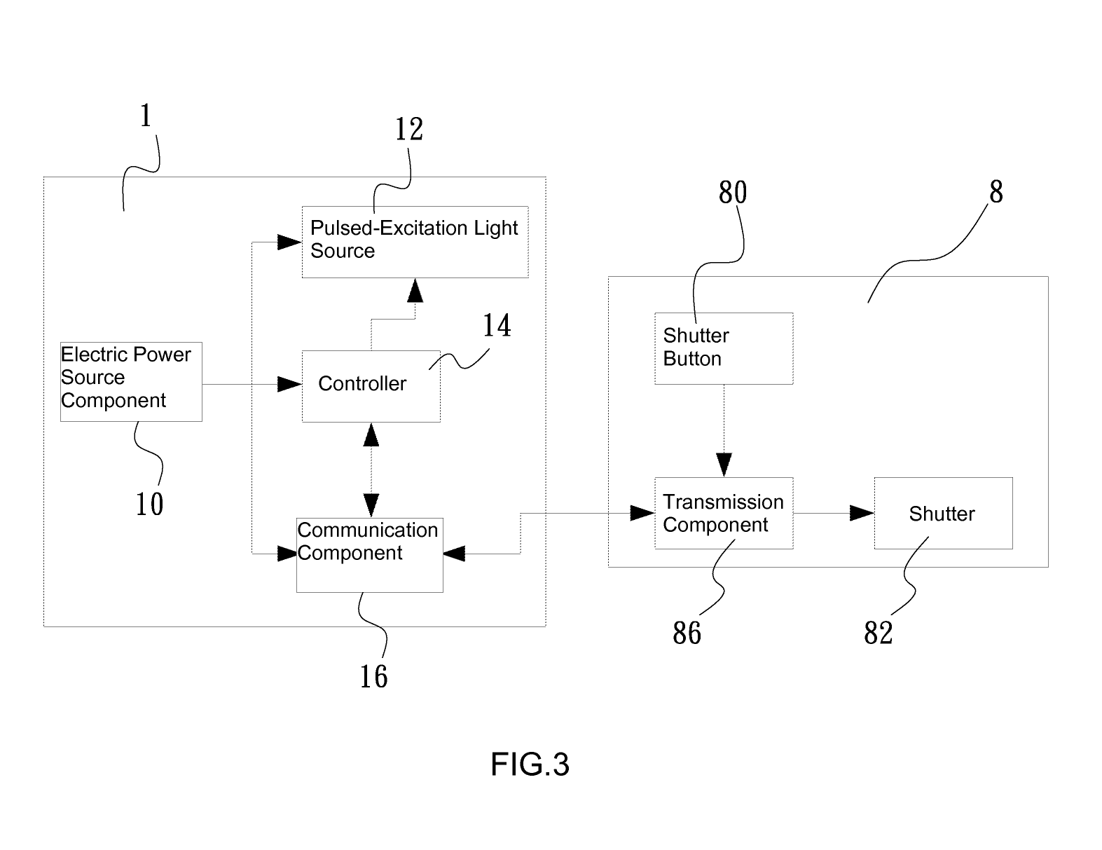

As shown in FIG. 3, the light source device for time-delayed detection of fluorescence 1 in the present embodiment operates in conjunction with a single lens reflex camera 8 and is installed at the front side of the single lens reflex camera 8; and also, seeing that at present the single lens reflex camera 8 can be already configured with USB connection ports and the Bluetooth™ communication device, it is possible to use the light source device 1 of the present embodiment as the excitation light source in taking fluorescent images so long as appropriate programs are previously set up in the camera. In the present embodiment, the light source device for time-delayed detection of fluorescence 1 essentially comprises: a power source component 10, a pulsed-excitation light source 12, a controller 14 and a communication component 16 exemplified as a Bluetooth™ device.

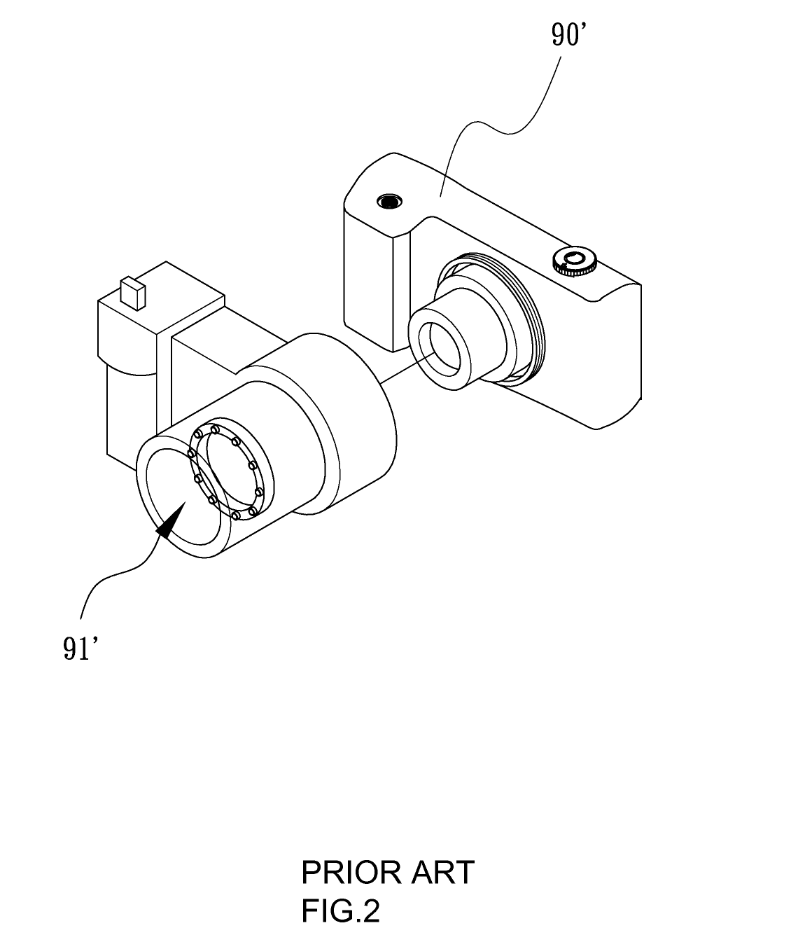

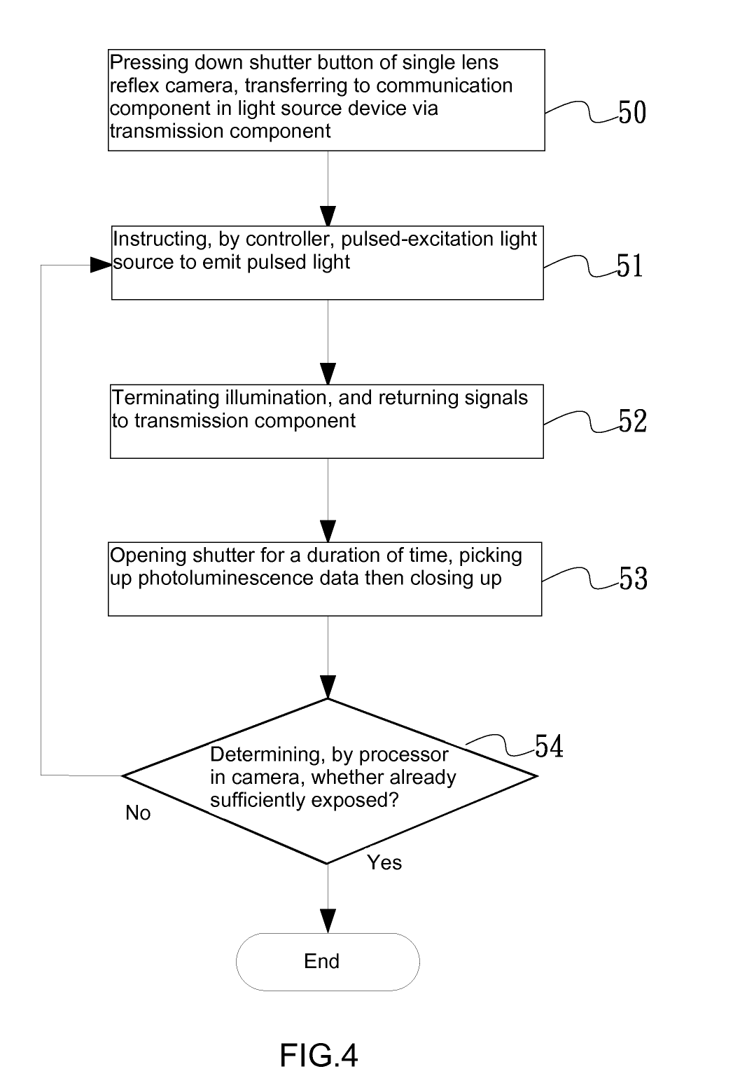

To facilitate brief illustrations, in the present embodiment, an event of evidence collections for criminal identification is taken as an example, and the appearance of the light source described in the present embodiment is basically similar to the one depicted in FIG. 2, wherein the single lens reflex camera 8 includes a shutter button 80, a shutter 82 and a transmission component 86 exemplified as a corresponding Bluetooth™ device. However, the major differences between them exist in that, a prior art camera shutter can open upon the light source illuminating, which also causes direct reflection light and diffusive reflection light interferences coming from the object under detection on the sensing component. Contrarily, once the single lens reflex camera 8 of the present embodiment starts to run the aforementioned programs, as shown in FIG. 4, when the user presses down the shutter button 80 on top of the single lens reflex camera 8 in a common fashion, at STEP 50, the camera shutter 82 does not open immediately but transmits instruction signals to the communication component 16 in the light source device 1 through the transmission component 86. In addition, at STEP 51, the controller 14 instructs the pulsed-excitation light source 12 exemplified as an ultraviolet LED to emit a pulsed light lasting for, e.g., 20 ms, then terminates the illumination at STEP 52 and feeds signals back to the transmission component 86 in the single lens reflex camera 8.

When the processor (not shown) in the camera receives the signals sent by the transmission component 86, the illumination of the pulsed-excitation light source 12 can be confirmed as being terminated, indicating that the direct reflection light and diffusive reflection light are synchronously disappeared, then, at STEP 53, the shutter 82 is allowed to open for 30 ms, for example, in order to pick up the weak photoluminescence data and subsequently close up. Also, due to the weakness in the photoluminescence data, such a short duration of time may not be enough to provide sufficient exposure, so, at STEP 54, the processor in the camera can decide to perform once again the loop serially including the pulsed light illumination of 20 ms, terminating as well as illumination and exposure of 30 ms, and repeat this loop of STEPs 51 to 53 until a sufficient exposure is achieved, thus successfully acquiring the image and stopping the loop.

Typically, in using light beams to excite fluorescent or phosphorescent light, most of the incident light beams, upon being projected onto the object under fluorescence or phosphorescence detection, will be directly reflected and returned or otherwise diffusively reflected and scattered, while the portion thereof actually absorbed by the fluorescence or phosphorescence material is in fact very little; accordingly, compared with the above-said direct reflection light and diffusive reflection light, the amount of the fluorescent light is extremely low. Although attempting to prevent the interference caused by the maximal direct reflection light with light source illumination angle alternations, if the diffusive reflection light enters into a camera lens or human eyes along with the fluorescent or phosphorescent light at the same time, the quality of the fluorescent or phosphorescent image under observation may be none the less seriously impaired.

Based on the fact that the phosphorescent light may last for several seconds, in case it is needed to verify whether an evidence contains any biologic specimen (e.g., sweat trace, semen trace, saliva trace etc.), a phosphorescent agent can be conjunctively applied, and the controller 14 in the light source device for time-delayed detection of fluorescence 1 instructs the shutter 82 to close up and commands the pulsed-excitation light source 12 to emit light, such as ultraviolet light, toward a predetermined detection location; thus, when this pulse cycle ends, returned reflection light and diffusive reflection light can be blocked out in a temporal difference way, thereby filtering the unwanted light beams directly reflected back from the target area, then the controller 14 outputs a signal to instruct the shutter 82 to open, so, at this moment, the phosphorescent image of the object under detection can be conveniently acquired.

In other word, using the controller 14 to manipulate the pulsed-excitation light source 12 and the open/close status of the shutter 82, it is possible to separate the reflection light from the photoluminescence information so as to obtain the appropriate phosphorescent image data. Of course, to capture a normal white light image as the reference base, the operator can detach the light source device for time-delayed detection of fluorescence in order to restore the natural light photographic environment and take the picture for comparing with the previously acquired photoluminescence image. Besides, since the photoluminescence intensity is significantly feeble, longer exposure time may be needed to achieve satisfactory photographic effects.

Through the aforementioned processes, the direct reflection light and the diffusive reflection originally constituting the source of interferences can be blocked out during the reflection time, but the initially weak photoluminescence image can be otherwise accumulated by way of multiple exposures so as to enhance the intensity of the image data; what is more, the shield installed at the foremost side can prevent the external noise light from entering, thus further improving the image quality and acquiring more accurate required information. Moreover, thank to functional advancements in mobile phones, camera phones equipped with the image pick-up system have already become the market mainstream, so the light source device according to the present invention can optionally work in conjunction with such camera phones in order to provide the photoluminescence image pick-up feature, e.g., for fluorescence or phosphorescence pictures, thereby greatly enhancing the application flexibility of the present invention.

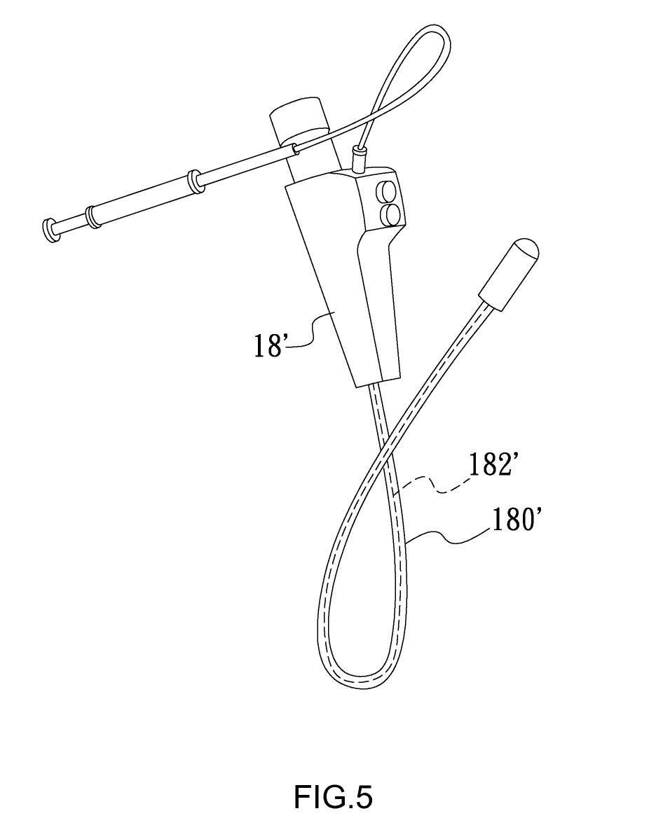

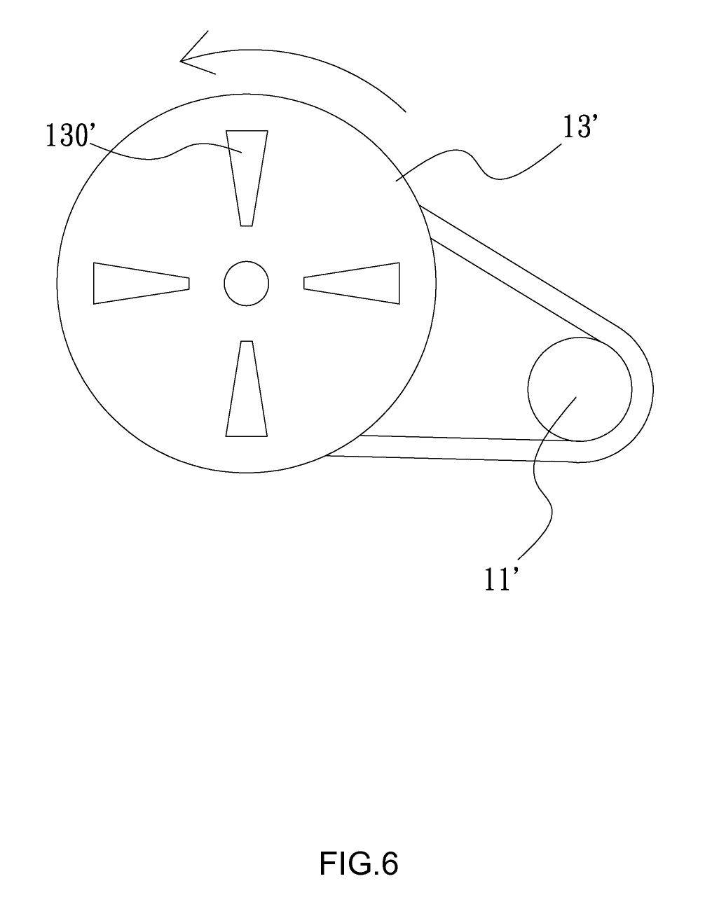

Certainly, as those skilled ones in the art can appreciate, the above-said shutter is not necessary separate in configuration from the light source device and by no means limited to a form of camera shutter, for example. In a second preferred embodiment of the present invention, as shown in FIG. 5, an endoscope utilized in medical fields is taken as an example, and the light source device for time-delayed detection of fluorescence comprises a housing 18′ and a shutter installed inside the housing 18′, wherein a flexible hollow case 180′ extends from the housing 18′ and can be bent to protect, mask and restrict the optical fiber 182′ embedded therein and referred hereunder as a light path. The incident light and the returned light have to be guided in transmissions via the optical fiber 182′ inside the flexible hollow case 180′. Also, a mechanical shutter shown in FIG. 6 is installed at the operation part of the endoscope, and a motor 11′ capable of 5,000 rotations per second drives an optical wheel 13′ to rotate, on the optical wheel 13′ there cut out multiple apertures 130′, herein four (4) apertures for example, so a time gap of 50 ns can be formed between each aperture 130′ and the next aperture 130′; in this way, when the open rate is 20%, it indicates there will be a light block-out time of 40 ns for every light transfer time of 10 ns.

As planned, within the light transfer time of 10 ns, the incident light emitted by the pulsed-excitation light source can pass through one of the apertures 130′ to enter into the optical fiber 182′; for brevity, this aperture is referred as an incidence aperture. Subsequently, when the aperture moves over the light entrance of the optical fiber and the illumination is interrupted by the wall of the optical wheel 13′, the fluorescent light returned via the optical fiber 182′ can be acquired by means of position synchronization on another aperture 130′, herein referring the aperture for the returned fluorescent light as a pick-up aperture. Seeing that the fluorescent light can usually last for a duration of 10⁻⁵ second, indicating an extension of approximately 10 ns after the end of illumination, so it is just possible to allow the fluorescent information to synchronously return to the image pick-up device, herein exemplified as a CCD, through the aforementioned pick-up aperture. Accordingly, by way of repeatedly performing multiple light incident and pick-up cycles, the fluorescent images thus obtained can be overlapped and accumulated so as to provide the clear fluorescent image data to a display, e.g., a common liquid crystal display, for further examinations or references by medical staff.

That is, the pulsed-excitation light source set forth in the present invention is not limited to the pulse-based illumination in itself; for example, the pulsed-excitation light source described in the present embodiment is characterized in the incidence aperture chiseled on the optical wheel thereby allowing the light incident to the optical fiber to demonstrate a pulse feature. In practice, it can be accomplished by first injecting multiple fluorescent materials, rich containing such as red, green, blue fluorescence etc., into a patient's body; allowing these fluorescent materials to selectively react and stay in the diseased tissues; using the pulsed-excitation light source to emit white light, for example; rotating the optical wheel and stopping the light path transmission so that the diseased tissues generate multiple fluorescent lights at the same time which can be returned via the optical fiber; and then acquiring all fluorescence data through the pick-up aperture acting as the shutter by means of an image pick-up device thus allowing the examiner to perform pathological diagnoses with human eyes or an external computer. Especially, since white light is applied in the present embodiment, it is possible to simply change the rotation speed of the motor to choose to acquire and observe the normal optical image.

Also, in application, the visual persistence in human eyes is about on an order of 1/15 second, meaning that even the image is observed directly through the eyepiece of the endoscope, the aforementioned temporal interval is so short that the observer may still see the returned fluorescent image data as a weak, continuous illumination signal without perceiving any blinks or discontinuities; hence, naked eye observations can be comfortably performed. Moreover, the appropriate form or quantity of the pulsed-excitation light source in the present embodiment can be configured in accordance with the space in the light source device for time-delayed detection of fluorescence.

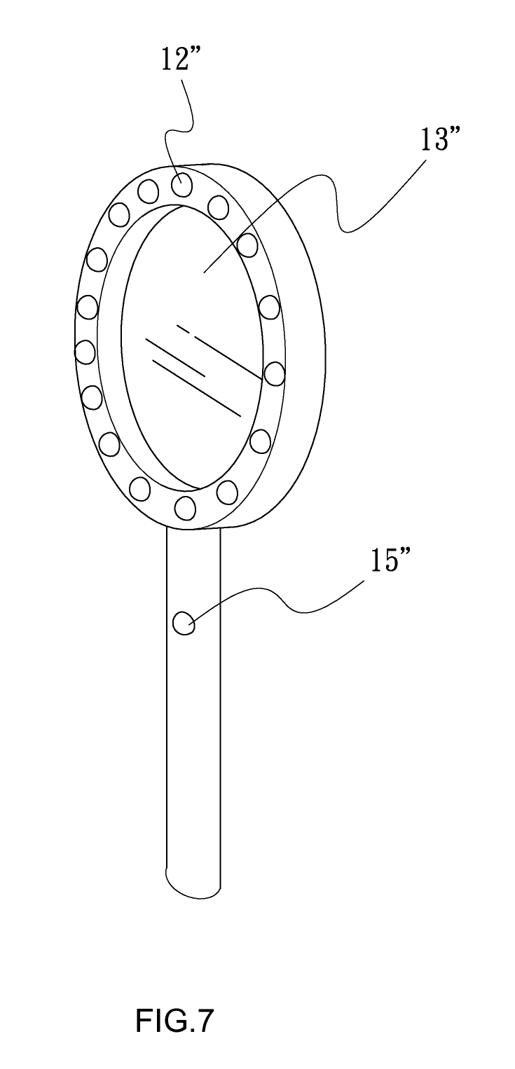

Furthermore, as shown in FIG. 7, in order to run a paper bill authentication, it can be accomplished by fabricating the image pick-up system according to the present invention in a form of magnifier, using a plurality of ultraviolet LEDs as the pulsed-excitation light source 12″ arranged in a ring configuration around perimeter of the shutter, and applying a liquid crystal module 13″ as the electronic shutter. When a user presses down the activation button 15″, the ultraviolet LEDs acting as the pulsed-excitation light source 12″ emits ultraviolet light which can last for 20 ns, for example, and project onto the paper bills under authentication. Without application of electric field, liquid crystal molecules in the liquid crystal module 13″ are in disorderly arrangement thus interrupting the entrance of light; after the end of ultraviolet light illumination, the electric field can be applied to the liquid crystal module 13″ such that the liquid crystal molecules in the liquid crystal module 13″ are aligned thereby allowing the subsequent photoluminescence image, i.e. the fluorescence or phosphorescence data etc., to pass. Similarly, the switch frequency in the electronic shutter and the LEDs is much higher than the observation speed of human eyes, so such rapid switches will not affect the operator's observations.

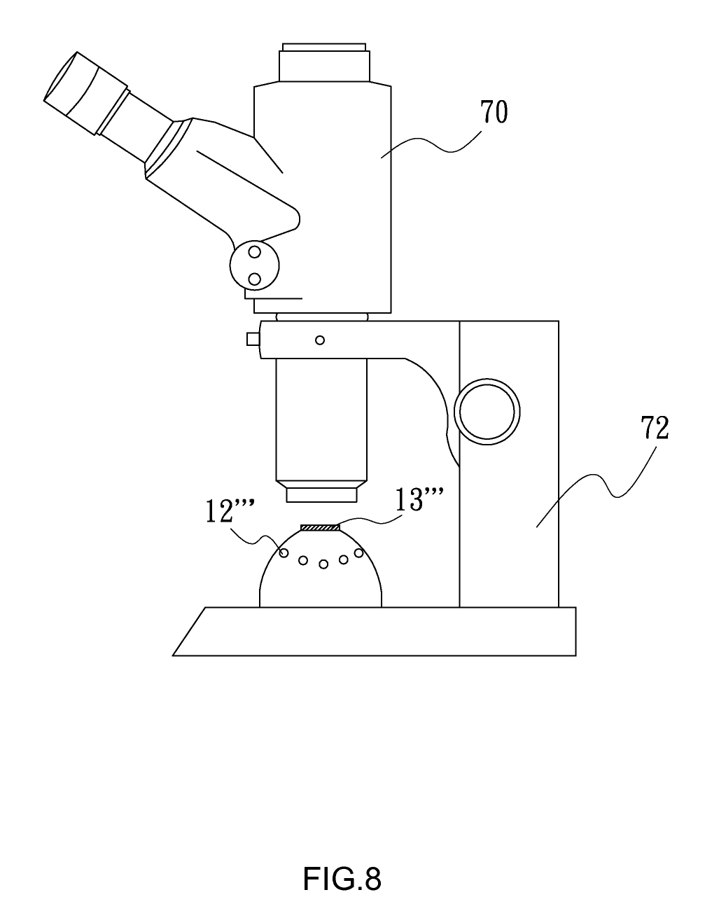

In addition, as shown in FIG. 8, many laboratories involving in biology related fields are usually equipped with the microscope 70 which can be detachably installed on a based 72; however, since the fluorescence microscope is much more expensive than the typical microscope, a general laboratory may provide this kind of microscope. Hence, in case an experiment needs to perform observations on fluorescent proteins, for example, it has to alternatively purchase the fluorescence microscope, which is an undesirable fashion of resource consumption. Therefore, in a fourth embodiment of the present invention, a light source device for time-delayed detection of fluorescence is installed in an auxiliary tool (not marked) in conjunction with a camera or video recorder disposed on a microscope to collectively constitute a photoluminescence image pick-up system.

Herein the pulsed-excitation light source 12′″ is placed within the shield in the auxiliary tool such that, on one hand, the shield can prevent external noise light and ambient light from entering into the object lens, and on the other hand, the shutter 13′″ is set up between the shield and the object lens in order to generate the aforementioned temporal difference thereby blocking out the direct reflection light and diffusive reflection light inside the shield, but allowing the fluorescence information to pass through the shutter 13′″ and enter into the lens for observation or recording operations. Certainly, to avoid possible wavelength interferences, in the present embodiment a filter lens can be also installed at the shutter 13′″ or other position along the light path such that interferences from noises of neighboring wavelengths can be further eliminated thus allowing the fluorescent microscopic image to satisfy the high detection and analysis requirements.

Therefore, based on the previously illustrated temporal difference feature, the present invention can effectively impede external ambient noise light, intense refection light or diffusive reflection light and allow the targeted photoluminescence image, i.e. the fluorescence or phosphorescence etc., to pass, which is fully compatible with conventional operation methods and enables more convenient acquisition of the intended photoluminescence image information as well as improved image quality. Moreover, the present invention can be easily connected to optical devices, such as a conventional camera, microscope, camera phone and so forth, or otherwise simply for human eye observations, thus providing more comprehensive applications; besides, it can operate in combination with a common natural light photographic system or else with direct observations such that the utilization flexibility thereof can be largely increased.

It should be noticed that, however, the illustrations set forth as above simply describe the preferred embodiments of the present invention which are not to be construed as restrictions for the scope of the present invention; contrarily, all effectively equivalent changes and modifications conveniently made in accordance with the claims and specifications disclosed in the present invention are deemed to be encompassed by the scope of the present invention delineated in the following claims.

It should be noticed that, although LED is used as the example of illumination method in above descriptions, it isn't the only way to excite fluorescence in this invention. Other illumination methods are also capable to achieve the same purpose in the following claims.

What is claimed is:

1. A light source device for time-delayed detection of fluorescence, adapted for use with a shutter to pick up a photoluminescence image of an object located at a predetermined detection site, the light source device comprising:
a pulsed-excitation light source for emitting light towards the predetermined detection site; and
a controller for instructing the pulsed-excitation light source to emit light, the controller being signal-connected to the shutter.

2. The light source device according to claim 1, further comprising a shutter which permits light to pass therethrough after a predetermined time delay following termination of light emission from the pulsed-excitation light source and for picking up the photoluminescence image of the object, upon being driven by the controller.

3. The light source device according to claim 2, further comprising a housing which defines a light path, wherein the shutter is mounted on the housing to block the light path when not being driven by the controller.

4. The light source device according to claim 3, wherein the housing comprises a flexible hollow case, and wherein the light path is an optical fiber embedded within the flexible hollow case.

5. The light source device according to claim 1, 2 or 3, further comprising a shield for preventing ambient light from reaching the predetermined detection site.

6. The light source device according to claim 5, further comprising a filter lens.

7. An image pick-up system provided with a light source device for time-delayed detection of fluorescence and adapted to pick up a photoluminescence image of an object located at a predetermined detection site, comprising:
a light source device for time-delayed detection of fluorescence, comprising a pulsed-excitation light source for emitting light towards the predetermined detection site, and a controller for instructing the pulsed-excitation light source to emit light;
a shutter device which is closed when the pulsed-excitation light source is turned on and adapted to be opened after a predetermined time delay following termination of light emission from the pulsed-excitation light source upon receipt of a feedback signal from the controller; and
an image pick-up device formed with an image data entrance corresponding to the shutter device.

8. The image pick-up system according to claim 7, wherein the shutter device is an electronic shutter.

9. The image pick-up system according to claim 8, wherein the electronic shutter is a liquid crystal module.

10. The image pick-up system according to claim 7, wherein the shutter device comprises a motor and an optical wheel driven to rotate by the motor, and wherein the optical wheel is formed with at least one aperture corresponding to the image data entrance.

11. A method of picking up a photoluminescence image of an object located at a predetermined detection site using an image pick-up system comprising a light source device for time-delayed detection of fluorescence, a shutter device and an image pick-up device, wherein the light source device comprises a pulsed-excitation light source for emitting light towards the predetermined detection site, and a controller signal-connected to the pulsed-excitation light source, and wherein the image pick-up device is formed with an image data entrance corresponding to the shutter device, the method comprising the steps of:
a) closing the shutter device, and allowing the controller to instruct the pulsed-excitation light source to emit light towards the predetermined detection site in a pulsed manner; and
b) instructing the shutter device to open after a predetermined time delay following termination of the pulsed light emission, so that the image pick-up device is allowed to capture image data through the image data entrance.

12. The method of picking up a photoluminescence image of an object according to claim 11, further comprising a step c) of repeating the steps a) and b) until a predetermined exposure condition is reached.
